(19) United States
(12) Patent Application Publication
(10) Pub. No.: US 2020/0013001 A1
(43) Pub. Date: Jan. 9, 2020

(54) Systems and Methods for Distributing Articles

(71) Applicant: Send Me A Sample Limited, London (GB)

(72) Inventors: William Glynn-Jones, London (GB); Richard Hill, London (GB); Rozzi Meredith, London (GB)

(21) Appl. No.: 16/027,431

(22) Filed: Jul. 5, 2018

(51) Int. Cl. G06Q 10/08; G06F 17/30

(52) U.S. Cl. CPC G06Q 10/087; G06F 3/167; G06F 17/30979

(57) ABSTRACT

This application relates to systems and methods of distributing orders for articles, in which a request is received from a user comprising an article identifier and a user identifier. The article identifier is compared with an inventory database which comprises a list of available articles, if the article identifier matches an available article, the user identifier is then compared with an identifier database which comprises a list of user identifiers and a corresponding list of articles previously supplied to each listed user identifier. If the article identifier is not listed in the identifier database as being previously supplied to the user identifier then a fulfilment request is forwarded to a fulfilment system and the article delivered to the user.

### BACKGROUND

In some circumstances, persons or companies may wish to give away products for free, or at a discount, to users. For example, a company wishing to promote a certain product, may give away products for free to encourage product recognition amongst a population in the hope of increasing future sales.

Such product giveaways may be done by advertising the “give away” in some manner (online, post, television adverts and the like). Once advertised, the company providing the products needs just to wait for users to mail in, ring, email or otherwise contact them to request a product. These types of giveaways are burdensome on the user who has to provide a lot of details to each provider to ensure they request and receive the right product. These giveaways are also burdensome on the provider as they will receive a lot of disparate requests, each with a different style, which causes a large workload to fulfil all the requests. Additionally, once started, these campaigns are difficult to stop and users may send many requests long after the product has run out. This can lead to users becoming disappointed and damage being caused to the public perception of the product or provider company.

To avoid these difficulties, many providers who wish to give away samples of their product employ people or teams of people to give away the product in busy public spaces (such as sports grounds, train stations and busy street corners). This method largely avoids over-requesting of the product (as once the product has gone, it's gone). However, this method is prone to users grabbing multiple products (diluting the possible product dispersion for a given number of products), provides limited or no control as to who the product is distributed to, leads to users taking products without substantial interaction with the company, and generally causes the product to be consumed at, and/or otherwise associated with, the place of distribution.

There therefore exists a need for improved systems and methods for distributing products which simplifies the distribution process for all parties and improves the control which can be had over the product distribution.

### SUMMARY

Aspects described herein improve the prior art systems and methods for distributing products by ensuring that articles are only sent to verified users who have not been sent the article before. To achieve this, an article request format is defined in which both information identifying the requesting user and information identifying the requested article must be provided. Identifying the requesting user allows the article provider to accurately track which articles are being requested and to ensure that the article is suitable for the requesting user.

The received request is checked against an inventory database to ensure that the requested article is in stock. By first ensuring the requested article is in stock before proceeding with additional steps, only requests which can possibly be fulfilled are further processed. Moreover, this ordering of steps causes a reduction in the number of times additional databases (which may contain sensitive user data) are accessed, thereby improving data security. This step also ensures that requests for out-of-date, expired and completed product giveaways are ignored without undue computational processing. Moreover, incorrect requests which do not correctly identify an article in stock, may be disregarded at this point, reducing unnecessary processing. Alternatively, identified incorrect requests may be quickly responded to with requests for further information, enabling the user to correct their request and avoiding incorrect requests being further processed. For large giveaways, with many different available articles, this check can significantly reduce the computational processing burden associated with managing the campaign. Once it has been confirmed that requested article is in stock, the request is then checked against an identifier database to ensure that the requested article has not been previously supplied to the user sending the request. It is therefore possible to easily restrict distribution of the available articles to a one-per-user basis. This restricted distribution helps ensure an optimal dispersal of the available articles amongst a group of users and better use of transporting resources, as compared to a first-come-first-served help-yourself arrangement.

A first aspect provides a system comprising: a processor; and memory storing computer readable instructions which, when executed, cause the system to perform a method of: receiving a request from a user, the request comprising an article identifier and a user identifier; comparing the article identifier with an inventory database, wherein the inventory database comprises a list of available articles; if or when the article identifier matches an available article, comparing the user identifier with an identifier database, wherein the identifier database comprises a list of user identifiers and a corresponding list of articles previously supplied to each listed user identifier; and if or when the article identifier is not listed in the identifier database as being previously supplied to the user identifier, forwarding a fulfilment request to a fulfilment system, the fulfilment request comprising the article identifier and the user identifier.

A second aspect provides one or more non-transitory computer readable media storing computer readable instructions which, when executed, cause a system to perform a method of: receiving a request from a user, the request comprising an article identifier and a user identifier; comparing the article identifier with an inventory database, wherein the inventory database comprises a list of available articles; if or when the article identifier matches an available article, comparing the user identifier with an identifier database, wherein the identifier database comprises a list of user identifiers and a corresponding list of articles previously supplied to each listed user identifier; and if or when the article identifier is not listed in the identifier database as being previously supplied to the user identifier, forwarding a fulfilment request to a fulfilment system, the fulfilment request comprising the article identifier and the user identifier.

In a third aspect, a distribution method comprises : receiving a request from a user, the request comprising an article identifier and a user identifier; comparing the article identifier with an inventory database, wherein the inventory database comprises a list of available articles; if or when the article identifier matches an available article, comparing the user identifier with an identifier database, wherein the identifier database comprises a list of user identifiers and a corresponding list of articles previously supplied to each listed user identifier; and if or when the article identifier is not listed in the identifier database as being previously supplied to the user identifier, forwarding a fulfilment request to a fulfilment system, the fulfilment request comprising the article identifier and the user identifier.

Other aspects described herein include systems, apparatus, data processing devices, and/or computer readable media configured to provide fulfilment systems as described herein. Further features are described below and in the appended claims.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 flow-chart showing a method in accordance with an illustrative embodiment;

FIG. 2 is a flow-chart showing a method in accordance with an illustrative embodiment;

FIG. 3 shows a graphical representation of an output in accordance with an illustrative embodiment;

FIG. 4 shows a system in accordance with an illustrative embodiment;

FIG. 5 shows a request processing system in accordance with an illustrative embodiment.

### DETAILED DESCRIPTION

As set out above, aspects described herein are directed to providing systems and methods for optimising the distribution of a number of articles between a number of users. The features set out below reduce the computational processing requirements for such systems and methods.

Large marketing campaigns, such as those comprising advertisements in nationwide television channels or national newspapers, can cause very high volumes of requests to be received by request handling servers in a very short amount of time (typically these request volumes spike shortly after distribution of the advert). Such high volumes of requests can overwhelm many computer servers due to the processing power required to process each request. Such spikes in volumes are comparable to malicious distributed denial of service (DDOS) attacks which are increasingly prevalent. Aspects described herein drastically reduce the number of received requests which are fully processed, which enables far higher volumes of requests to be handled without overwhelming the computer server.

Aspects described herein provide methods of organising and processing requests which improve computational efficiency. For example, large giveaways may comprise several different options or forms of an article (such as different colours, or flavours of a product). Midway through a giveaway, one or more of the options may run out of stock. Aspects described herein ensure that requests relating to articles no longer in stock are quickly disregarded without being fully processed, reducing the computational processing load across the system.

Moreover, data security in such systems and methods is improved by limiting use of computer databases which comprise sensitive user information to those requests which meet a predefined data format and an article availability check. Aspects described herein provide methods in which databases containing sensitive user data are only accessed after initial checks on availability of requested items. Each rejected request corresponds to at least one fewer user data database query as compared to prior art methods of processing such requests. This ordering of requests significantly reduces accessing of sensitive user data in such computational systems. Moreover, these systems and methods enable restricted distribution schemes which optimise dispersal of available articles and better use of transporting resources, as compared to the prior art methods.

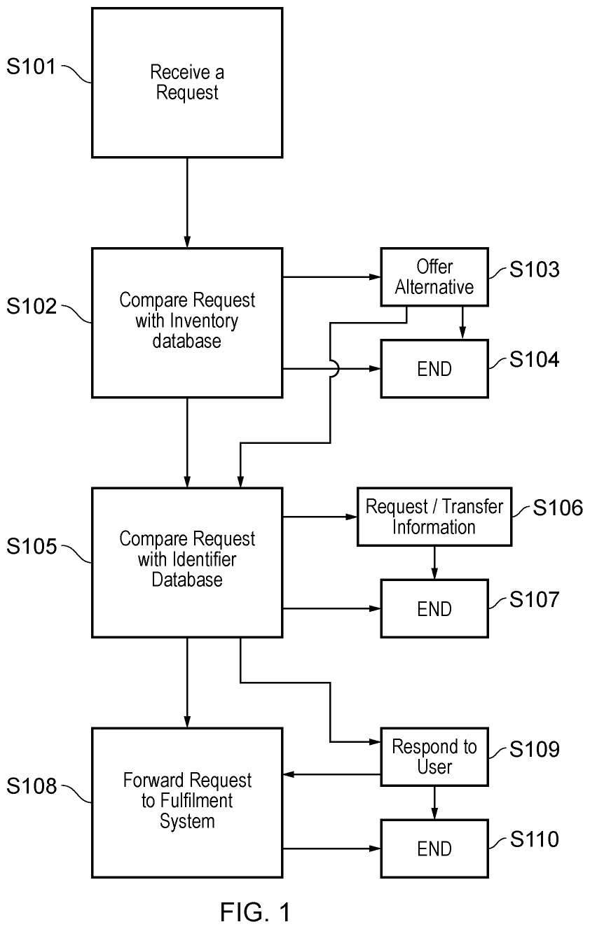

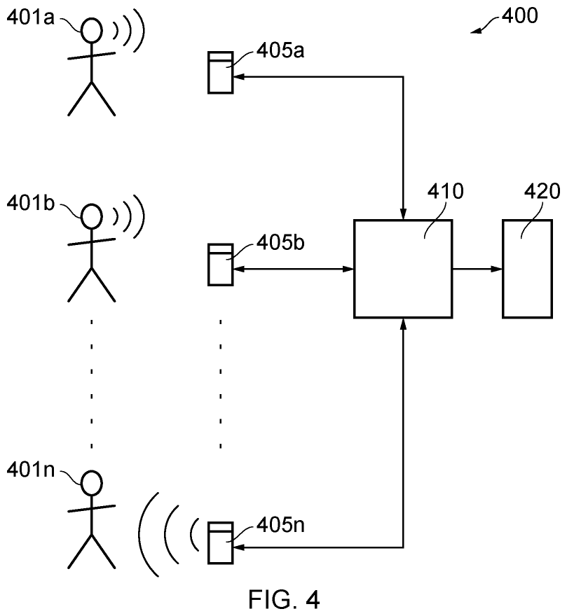

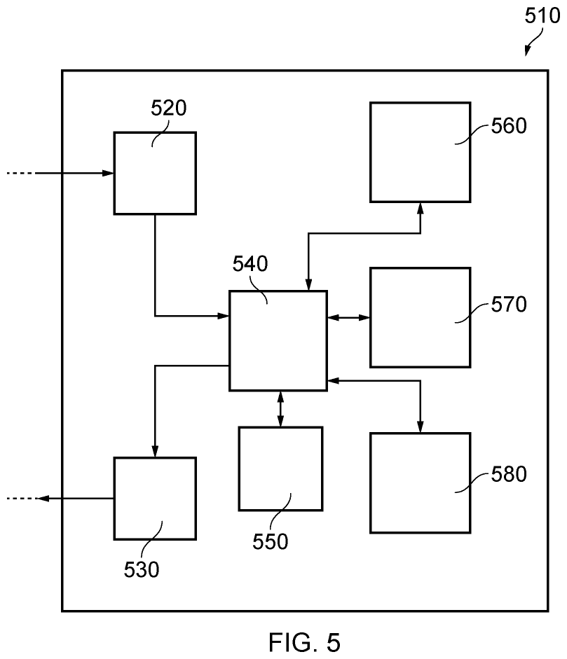

A first illustrative embodiment will now be described with reference to FIG. 1. FIG. 1 shows a flow chart setting out an order distribution method. At step S101, a request is received, at a server, from a user. This method may be run on any suitable computer hardware, including a processor and a memory containing processor readable instructions which when read by the processor, perform the following steps. The computer hardware upon which this method may run will be described in more detail later on, in reference to FIGS. 4 and 5.

The received request comprises an article identifier. The article identifier may be used to identify the article that the user is requesting from the supplier. The article identifier may be any form of data which can help identify the article, including one or more of: a class of article, a type of article, an article manufacturer, a brand of article, a name of an article, a pre-defined keyword, a stock keeping unit (SKU) and so on.

The request also comprises a user identifier. The user identifier is used to identify the source of the request. The user identifier may be any form of data which can help identify the user, including one or more of: a unique user identifier, a unique request source identifier (i.e. a physical or virtual source identifier) and an originating address of the request (including either a physical postal address or a virtual address). The user identifier may also be a user name, a user address, a user login name, a user email address or any other data which can be used to identify a user (either directly or by reference to a user identity database).

At this stage in the method, the request may be checked to ensure it comprises both an article identifier and a user identifier. If either or both of these is missing, a message may be sent back to the user requesting clarification of the missing identifier. The format and details of such message will be described in more detail below.

Once a complete request has been received, the method compares, S102, the article identifier with an inventory database. The inventory database comprises a list of all of the articles that are currently available to be supplied. This comparison step compares the requested article with the list of available articles to see if the requested article is in stock.

If the requested article is not in stock, or is not currently listed in the inventory database, the user may be sent a message S103, offering them an alternative. The alternative may be, for example, an alternative but related article, a coupon or voucher for the requested article, or advice on when the requested article may be back in stock. If there is no suitable alternative, or if the user rejects the offered alternative, the process ends at step S104. In some circumstances, the process may end S104 as soon as the requested article is identified as not listed in the inventory database.

If the requested article is listed as in stock in the inventory database, or a suitable alternative is accepted by the user, the method moves on to step S105. At step S105, the user identifier is compared with an identifier database. The identifier database may be part of the inventory database or a separate database. For data security reasons, it is preferred that the two databases are separate, to limit access to information which can identify users of the distribution system.

The identifier database comprises data which may identify users (such as a list of user identifiers). This user identification data is linked to a list of articles that have been previously supplied to each user listed in the identifier database. For some users, no items will have been previously supplied. In this case, they may not be listed in the identifier database. Whereas some users may have had many items supplied in the past.

If the comparison step at S105 does not find the user identifier in the identifier database, the user may not have been correctly set up in the system. In this case, the user is sent, S106, a message requesting one or more further user identifiers to establish their identity. The message may also include one or more instructions to enable a new user to be set up in the system. The user may return further user identification information enabling the comparison step S105 to be rerun. This process can be repeated until the identity of the user is established or until the user no longer replies. In the case of no further replies being received, the process ends at step S106.

Once the comparison of step S105 finds the user identifier in the identifier database, the article identifier is then compared to the list of articles that have been previously supplied to that user. If the article identifier is not listed in the identifier database as being previously supplied to the user, a fulfilment request is forwarded, S108, to a fulfilment system. The fulfilment request comprises at least the article identifier and the user identifier. With this information the fulfilment system may supply the requested article to the user, using any known method of delivery. Once this fulfilment request has been sent, the process may end at step S110.

If the article identifier is listed in the identifier database as being previously supplied to the user, no fulfilment request is forwarded. This method stops the same article being sent to the same user more than once. In this situation, the method may respond to the user at step S109. The response of step S109 may, for example, include a request for payment for the article (after receipt of such payment a fulfilment request may be sent S108). The response of step S109 may also include an indication of an identified alternative article which may be supplied to the user (the acceptance of which may lead to a fulfilment request being sent S108). The response of step S109 may also include an indication that no suitable articles corresponding to the article identifier are available. After this, the process ends at step S110.

In some embodiments, the request may be received from a voice activated interface. The voice activated interface may be, for example, a voice activated assistant such as Amazon's Alexa®, Google Home®, Google Assistant®, Apple's Siri® and/or Apple HomePod®. Where a voice activated interface is used, the request received by the above described method may be at least in part an audio recording of the user's voice and/or may be at least in in part data extracted from an audio recording of the user's voice. One advantage of receiving requests via a voice interface is that the process of generating the request for the user may be considerably simplified. Data-from-audio extraction processes may be used to simply extract the expected data from an audio clip received from a user as part of the request.

Whether or not a voice activated interface is used to create the request, the above described method may return messages to the user which comprise audio portions and/or data configured to be output as audio. Such messages may request further information from the user, provide feedback to the user about the progress of the above defined method, reject requests made by a user, or talk users through setting up their user identifier. Any message sent by the method back to the user may be sent in this way. However, the exact content of such messages is not important for the understanding of the aspects described herein and so will not be discussed further.

Either or both of comparison steps S102 and S105 may be performed by comparing an audio recording with an expected audio clip. The expected audio clip may comprise an expected format of a request, an expected article identifier and/or an expected user identifier format. Similarly, comparison steps S102 and S105 may be performed by comparing data extracted from an audio recording with expected data.

Comparison steps S102 and S105 may be performed in either order or simultaneously. One advantage of performing step S102 before S105 is that some requests may be rejected for lack of available articles before the identifier database needs to be accessed. This reduces the amount of times sensitive user data may be accessed, which improves data security.

In some embodiments, before the step S108 of forwarding the fulfilment request, a further comparison may be performed. The user identifier and/or the article identifier may be compared with a permissions database and the fulfilment request may only be forwarded if the user identifier is not listed in the permissions database or the article identifier does not correspond to an article restriction linked to the user identifier. If the user identifier is not listed in the permissions database, it may be presumed that the user associated with the user identifier does not wish to set any restrictions in the permissions database.

The permissions database comprises a list of user identifiers and one or more article restrictions linked to said listed user identifiers. The article restrictions may be any article indicator, or type of article indicator, which a user may wish to restrict access to. The article restrictions may be one or more of an age rating (which may stop users from receiving age-restricted articles such as alcohol), an article type, an article weight and an article cost.

To further aid data security, some or all of the data stored in the inventory database, the identifier database and/or the permissions database may be encrypted. Any known encryption protocol may be used. Additionally, the article identifier and/or the user identifier may be encrypted or mathematically abstracted (using a hash algorithm for example). The mathematically abstracted article identifier and/or user identifier may then be compared with a similarly abstracted inventory database, identifier database and/or permissions database to perform the comparison steps described above in a more secure manner.

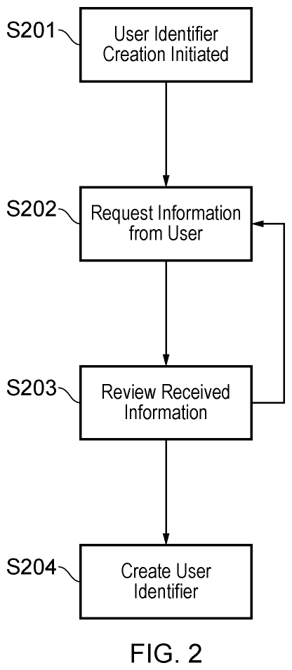

Voice activated interface embodiments may advantageously aid a user in initially setting up or otherwise creating a user identifier, as will be described by reference to FIG. 2. FIG. 2 illustrates a method of creating a user identifier. At step S201, the process to create a user identifier is initiated. The method of FIG. 2 may be initiated by a user before they first send a request. Alternatively, this method may be initiated in response to the method of FIG. 1 not recognising a user identifier in one of the comparison steps.

At step S202, a request for information is sent to the user. The request for information may request any data which can help identify the user, including one or more of: a unique user identifier, a unique request source identifier (i.e. a physical or virtual source identifier) and an originating address of the request (including either a physical postal address or a virtual address). The request may also ask for a user name, a user address, a user login name, a user email address or any other data which can be used to identify a user (either directly or by reference to a user identity database).

At step S203, some or all of the requested information is received. The received information is reviewed to ensure that it includes all required data to create a user identifier. If one or more data is missing, a further request for information S202 may be sent to the user.

If all of the required data is complete, at step S204, a user identifier is created and added to the identifier database. At this point the process ends.

A particular advantage of using a voice activated interface to perform this method is that the user may provide natural language responses to the request for information, improving their experience. Moreover, the review and request for further information steps enable a user to be guided through the creation of a user identifier in a simple and natural manner. It is contemplated that the above described voice led method of setting up a user interface may alternatively be completed by any other means of user input, such as a keyboard, mouse or touchscreen interface.

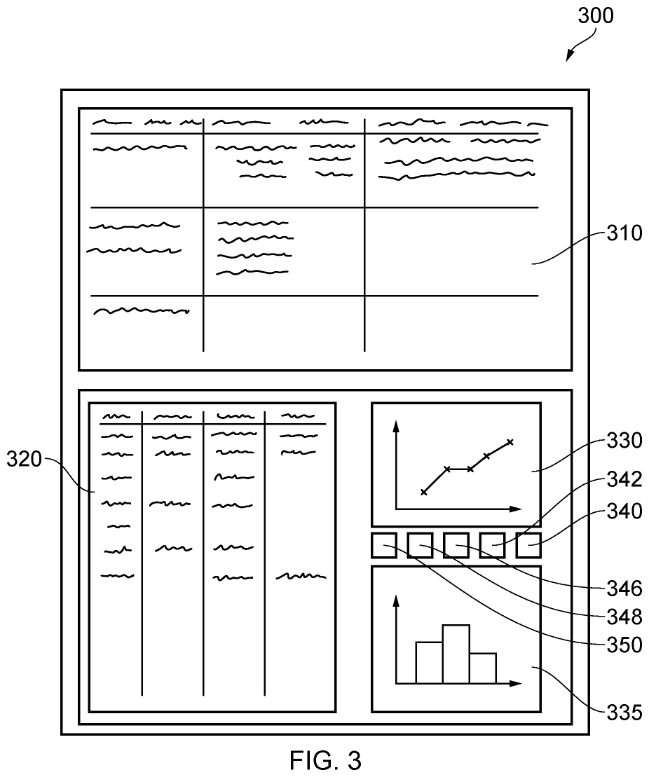

FIG. 3 illustrate a schematic representation of a user interface 300 which may be available, continuously, during or at the end of each instance of the method of FIG. 1 being performed. The user interface 300 may provide a manager of the methods described herein a summary 310 of the articles listed in the inventory database. Additionally, the user interface 300 may provide a manager a summary 320 of the identifier database.

The user interface 300, and the data illustrated therein, may be updated continuously, periodically or after each fulfilment request is forwarded to the fulfilment system. The data illustrated by the user interface may be represented or summarised in graphical form, as illustrated by graphs 330 and 335. The layout and contents of the user interface 300 could be configured in many different ways, only one of which is illustrated here. The user interface is arranged to enable a user to understand the contents of the inventory database and/or the identifier database. The user interface may also be arranged to enable a user to track changes in the inventory database and/or the identifier database over time.

Additionally, the user interface 300 may comprise a series of inputs 340, 342, 344, 346, 348 and 350. Five inputs are shown in the user interface 300, however any number of inputs may be used. Moreover, external inputs such as a keyboard, mouse or voice interface may be used. The inputs 340 to 350 enable a user to make alterations to the data illustrated in the user interface. These alterations may then alter the inventory database and/or the identifier database, changing the outcomes of the methods described above. The user interface may therefore be used to add additional articles in the inventory, remove articles, add additional user identifiers, remove user identifiers, or adjust any of these variables.

One advantage of providing such a user interface is that the distribution methods described herein may be easily initiated, tracked, adjusted or stopped by a user.

FIG. 4 illustrates a system 400 in accordance with an illustrative embodiment. FIG. 4 illustrates a plurality of users 401a to 401n. In FIG. 4, three users are illustrated. However, the system is arranged to be scaled such that any number of users can interact with the system 400 at the same time. Each of users 401a to 401n are illustrated in conjunction with an interface 405a to 405n. Interfaces 405 to 405n may be voice activated assistants or any other type of input, such as a computer, a smart TV, a mobile telephone, a fixed telephone, a PDA and so forth.

Interfaces 405a to 405n are arranged to receive inputs from their respective users 401a to 401n. Inputs include, for example, the request for an article described in conjunction with FIG. 1. Additionally, interfaces 405a to 405n may be arranged to output instructions, commands or any other type of message to their respective users. Exemplary inputs and outputs have been described above in connection with FIGS. 1 to 3.

Interfaces 405a to 405n are connected to a request processing system 410. The interfaces may be connected to the request processing system by any known method of connecting devices such as a Local Area Network, a cable data network, the Internet and/or a wireless data connection. The request processing system 410 may comprise one or more processors and memory (not shown) suitable for performing the methods described in relation to FIGS. 1 to 3. Therefore, the request processing system 410 is arranged to receive requests from one of more of users 401a to 401n, via interfaces 405a to 405n, and perform the methods described above.

System 400 may further comprise a fulfilment system 420. The fulfilment system is arranged to receive fulfilment requests from the request processing system and thereafter fulfil said requests. These requests may be fulfilled by, for example, identifying the requested article and sending said article to the user by postal delivery.

FIG. 5 is a schematic diagram showing a request processing system 410/510 in more detail. The request processing system is arranged to perform the methods described above in relation to FIGS. 1 to 3. The request processing system 510 may form part of a standalone computer server or may be realised in a cloud-based computational system such as Amazon Web Services® or Microsoft Azure®. Request processing system 510 comprises an input 520 and an output 530. The input 520 is arranged to receive data from one or more users (not shown). The input 520 may also receive data from a user interface (now shown) as described in relation to FIG. 3. The output is arrange to send data to one or more users (not shown), one or more fulfilment systems (not shown) and one or more user interfaces (not shown).

The request processing system 510 also comprises one or more processors 540. Processor 540 may be a single core or a multi-core processor. Processor 540 is in operable communication with both the input 520 and the output 530. The processor is arranged to receive data from input 520 and sent data to output 530.

The request processing system 510 also comprises one or more memories 550. Memory 550 is in data communication with processor 540. Memory 550 may be any form of volatile or non-volatile memory. Memory 550 may be arranged to store computer readable instructions which, when executed by processor 540, cause the system 510 to perform any of the methods described herein. Memory 550 may also be arranged to store received requests, message, or any other form of data described herein.

The request processing system 510 may also comprise a separate inventory database 560, identifier database 570 and/or permissions database 580. Each of these databases is in data communication with processor 540. These databases may be formed as a single database, or in any combination of two databases. These databases may be any form of volatile or non-volatile memory. These databases may also be formed entirely within memory 550.

One or more aspects described herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects, and such data structures are contemplated within the scope of computer executable instructions and computer-usable data described herein.

The above embodiments describe various ways of implementing aspects described herein. It will be appreciated that modifications of the features of the above embodiments are possible within the scope of the independent claims. While particular combinations of features have been presented in the claims, it will be appreciated that other combinations, such as those provided above, may be used.

1. A system, comprising:
a processor; and
memory storing computer readable instructions which, when executed, cause the system to perform a method of:
receiving a request from a user, the request comprising an article identifier and a user identifier;
comparing the article identifier with an inventory database, wherein the inventory database comprises a list of available articles;
when the article identifier matches an available article, comparing the user identifier with an identifier database, wherein the identifier database comprises a list of user identifiers and a corresponding list of articles previously supplied to each listed user identifier; and
when the received article identifier is not listed in the identifier database as being previously supplied to the received user identifier, forwarding a fulfilment request to a fulfilment system, the fulfilment request comprising the article identifier and the user identifier.

2. The system of claim 1, wherein the request is received from a voice activated interface, and wherein at least one of the article identifier and/or the user identifier are extracted from an audio recording forming part of the request provided by the voice activated interface.

3. The system of claim 2, wherein the audio recording is compared with an expected audio clip, and wherein the request is ignored if the audio recording does not at least partially match the expected audio clip.

4. The system of claim 2, wherein if an article identifier and/or user identifier cannot be extracted from the audio recording, a message is returned to the user, wherein the message delivers or requests further information from the user.

5. The system of claim 4, wherein the message comprises an audio portion, the audio portion comprising one or more of: a verbal request, a verbal command and a verbal explanation.

6. The system of claim 1, further arranged to:
before forwarding the fulfilment request, compare the received user identifier and the received article identifier with a permissions database, wherein the permissions database comprises a list of user identifiers and one or more article restrictions linked to said listed user identifiers, wherein the fulfilment request is only forwarded when the received user identifier is not listed in the permissions database or the received article identifier does not correspond to an article restriction linked to the received user identifier.

7. The system according to claim 6, wherein the article restrictions comprise one or more of: an age rating, an article type, an article weight and an article cost.

8. The system according to claim 1, wherein when the received user identifier does not match any user identifier listed in the identifier database, a message is returned to the user, wherein the message delivers or requests further information from the user.

9. The system according to claim 8, wherein the message includes instructions to the user detailing information required to list the received user identifier in the identifier database, wherein the required information comprises one or more of: a user name, a postal address, a password, a user age, an article preference and an article restriction.

10. The system according to claim 1, wherein when the received article identifier does not match an available article, the method further comprises:
identifying an alternative article and responding to the request with an indication of the identified alternative article; or
responding to the request with an indication that none of the articles corresponding to the received article identifier are available; or
responding to the request with a request for payment.

11. The system according to claim 1, wherein when the received article identifier is listed in the identifier database as being previously supplied to the user identifier, the method further comprises:
identifying an alternative article and responding to the request with an indication of the identified alternative article; or
responding to the request with an indication that none of the articles corresponding to the received article identifier are available; or responding to the request with a rejection indication.

12. The system according to claim 6, wherein the data stored in the inventory database, the identifier database and/or the permissions database is encrypted.

13. The system of claim 1, wherein the computer readable instructions are further arranged to:
provide, to a second user, a database summary,
wherein the database summary comprises a summary of the inventory database and/or the identifier database.

14. The system of claim 13, wherein the computer readable instructions are further arranged to:
update the database summary after a fulfilment request is forwarded to the fulfilment system.

15. The system of claim 1, wherein the computer readable instructions are further arranged to perform:
receiving, from a second user, one or more alterations to the inventory database, wherein the one or more alterations to the inventory database comprise one or more of: listing an additional available article or removing an available article.

16. The system of claim 1, further comprising:
a voice activated interface in data communication with the processor, the voice activated interface arranged to receive the request from the user.

17. The system of claim 16, wherein the voice activated interface is further arranged to provide to the user a message which delivers information to, and/or requests further information from, the user.

18. The system of claim 1, further comprising:
a fulfilment system in data communication with the processor, the fulfilment system arranged to receive the fulfilment request and arrange delivery to the user of an article corresponding to the article identifier based on the request.

19. One or more non-transitory computer readable media storing computer readable instructions which, when executed, cause a system to perform a method of:
receiving a request from a user, the request comprising an article identifier and a user identifier;
comparing the article identifier with an inventory database, wherein the inventory database comprises a list of available articles;
when the article identifier matches an available article, comparing the user identifier with an identifier database, wherein the identifier database comprises a list of user identifiers and a corresponding list of articles previously supplied to each listed user identifier; and
when the received article identifier is not listed in the identifier database as being previously supplied to the received user identifier, forwarding a fulfilment request to a fulfilment system, the fulfilment request comprising the article identifier and the user identifier.

20. A distribution method comprising the steps of:
receiving, at a server, a request from a user, the request comprising an article identifier and a user identifier;
comparing the article identifier with an inventory database held on the server, wherein the inventory database comprises a list of available articles;
when the article identifier matches an available article, comparing the user identifier with an identifier database held on the server, wherein the identifier database comprises a list of user identifiers and a list of article identifiers corresponding to articles previously supplied to each listed user identifier; and
when the received article identifier is not listed in the identifier database as being previously supplied to the received user identifier, forwarding a fulfilment request to a fulfilment system, the fulfilment request comprising the received article identifier and the received user identifier.
